(19) United States
(12) Patent Application Publication
(10) Pub. No.: US 2026/0302051 A1
(43) Pub. Date: Oct. 1, 2026

(54) COIL COMPONENT AND METHOD FOR MANUFACTURING THE COIL COMPONENT

(71) Applicant: TAIYO YUDEN CO., LTD., Tokyo (JP)

(72) Inventor: Hirotaka WAKABAYASHI, Tokyo (JP)

(21) Appl. No.: 19/567,654

(22) Filed: Mar. 16, 2026

(30) Foreign Application Priority Data
Mar. 27, 2025 (JP) 2025-054558

(51) Int. Cl. H01F 27/29; H01F 1/03

(52) U.S. Cl. CPC H01F 27/292; H01F 1/0315

(57) ABSTRACT

A coil component includes a base body containing metal magnetic particles and a resin; a coil conductor disposed in the base body; external terminals electrically connected to the coil conductor and disposed on a surface of the base body; and a first metal oxide film disposed on surfaces of the metal magnetic particles at an interface between the external terminals and the base body, the first metal oxide film being in contact with the external terminals.

### CROSS-REFERENCE TO RELATED APPLICATIONS

This patent application is based on and claims priority to Japanese Patent Application No. 2025-054558 filed on Mar. 27, 2025, the entire contents of which are incorporated herein by reference.

### TECHNICAL FIELD

The present disclosure relates to a coil component and a method for manufacturing the coil component.

### BACKGROUND

It is known that a coil conductor is disposed in a base body containing metal magnetic particles and a resin, and that external terminals electrically connected to the coil conductor are disposed on a surface of the base body. It is known that a lowermost layer of the external terminals is formed by substitution plating using a plating bath containing metal ions having ionization tendency lower than that of the metal magnetic particles (e.g., Patent Document 1). It is also known that external terminals are formed after irradiating the surface of the base body with laser light (e.g., Patent Documents 2 to 4).

### RELATED ART DOCUMENTS

### Patent Documents

Patent Document 1: Japanese Patent Laid-Open No. 2010-186909
Patent Document 2: Japanese Patent Laid-Open No. 2016-58418
Patent Document 3: International Publication No. 2017/135057
Patent Document 4: International Publication No. 2017/135058

### SUMMARY

According to an embodiment of the present disclosure, a coil component is provided. The coil component includes: a base body containing metal magnetic particles and a resin; a coil conductor disposed in the base body; external terminals electrically connected to the coil conductor and disposed on a surface of the base body; and a first metal oxide film disposed on a surface of the metal magnetic particles at an interface between the external terminals and the base body, the first metal oxide film being in contact with the external terminals.

According to another embodiment of the present disclosure, a method for manufacturing a coil component is provided, The method includes: preparing a base body containing metal magnetic particles and a resin, with a coil conductor embedded in the base body; forming a metal oxide film on surfaces of the metal magnetic particles on a surface of the base body; and forming external terminals on the surface of the base body, the external terminals being electrically connected to the coil conductor, and the metal oxide film being disposed between the external terminals and the metal magnetic particles.

### BRIEF DESCRIPTION OF THE DRAWINGS

FIG. 1 is a perspective view of a coil component according to a first embodiment.

FIG. 2 is a cross-sectional view taken along line A-A of the coil component according to the first embodiment.

FIG. 3 is a cross-sectional view of the coil component according to the first embodiment.

FIG. 4 is a cross-sectional view of an interface between a base body and an external terminal in the first embodiment.

FIG. 5A and FIG. 5B are cross-sectional views illustrating a method for manufacturing the coil component according to the first embodiment.

FIG. 6 is a cross-sectional view of an interface between a base body and an external terminal in a comparative embodiment.

FIG. 7 is a TEM (Transmission Electron Microscope) image of an interface between a metal magnetic particle and a first metal layer in an example.

FIG. 8 is a TEM image of an interface between a metal magnetic particle and a first plating layer in the example.

FIG. 9 is an EELS (Electron Energy-Loss Spectroscopy) spectrum of a metal oxide film in the example.

FIG. 10 is an SEM (Scanning Electron Microscope) image of the base body before laser light irradiation in the example.

FIG. 11 is a TEM image of an interface between a metal magnetic particle and a first plating layer in the example.

### DETAILED DESCRIPTION

When an external terminal is formed in contact with metal magnetic particles, the metal magnetic particles may be substituted with a metal element such as copper of the external terminal during the plating process for forming the external terminal. Additionally, the metal magnetic particles may dissolve in the plating solution during the plating process. This reduces the volume of the metal magnetic particles, leading to degradation of electrical characteristics, such as reduced inductance of the coil component. Furthermore, the bonding strength or durability between the base body and the external terminal may decrease, potentially causing reduced reliability.

According to the present disclosure, a coil component and a method for manufacturing the coil component capable of suppressing degradation of characteristics can be provided.

Embodiments of the present disclosure will be described in detail below, but the present disclosure is not limited thereto. In the specification and drawings, components having substantially the coil component functional configuration may be denoted by the coil component reference numerals to omit redundant description.

### First Embodiment

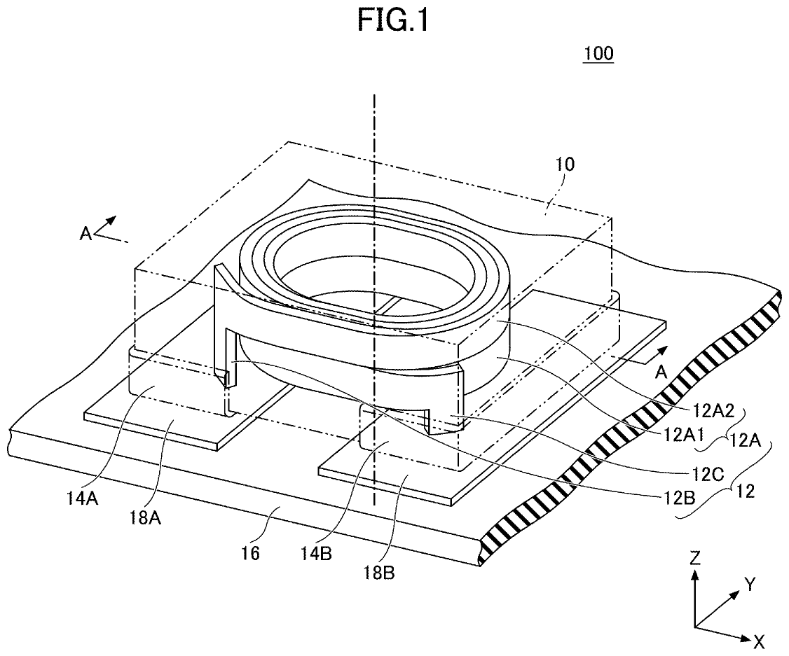

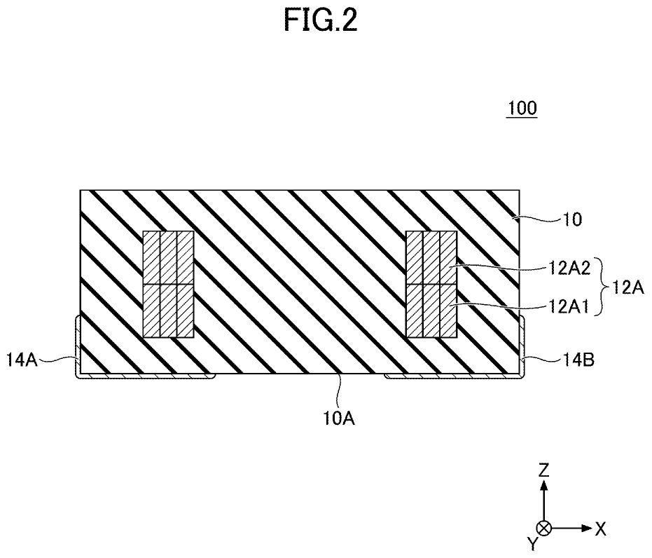

FIG. 1 is a perspective view of a coil component according to the first embodiment. FIG. 2 is a cross-sectional view taken along line A-A of the coil component according to the first embodiment. The thickness direction of a base body 10 is defined as the Z direction, the arrangement direction of external terminals 14A and 14B as the X direction, and the direction orthogonal to the X direction and Z direction as the Y direction.

As illustrated in FIGS. 1 and 2, a coil component 100 includes the base body 10, a coil conductor 12, and the external terminals 14A and 14B. The base body 10 has a substantially rectangular parallelepiped shape. The coil conductor 12 is disposed in the base body 10 and has a winding portion 12A and lead-out portions 12B and 12C. The winding portion 12A is a portion forming an inductor. The winding portion 12A has a first winding portion 12A1 and a second winding portion 12A2. The first winding portion 12A1 and the second winding portion 12A2 are arranged in the Z direction. The number of turns of the coil in each of the first winding portion 12A1 and the second winding portion 12A2 is three. The number of stacked layers of the first winding portion 12A1 and the second winding portion 12A2 in the winding portion 12A may be one layer or three or more layers instead of two layers. The number of turns in the first winding portion 12A1 and the second winding portion 12A2 may be less than one or one or more. The number of turns in the first winding portion 12A1 and the second winding portion 12A2 is, for example, less than six, and less than four. The coil conductor 12 in the winding portion 12A is flat with a longer dimension in the Z direction relative to its thickness. The coil conductor 12 may have a shape other than flat.

One end of the first winding portion 12A1 and one end of the second winding portion 12A2 are electrically connected inside the winding portion 12A. One end of the lead-out portion 12B is electrically connected to the other end of the second winding portion 12A2, and one end of the lead-out portion 12C is electrically connected to the other end of the first winding portion 12A1. The lead-out portions 12B and 12C extend in the-Z direction, and the other ends of the lead-out portions 12B and 12C are connected to the external terminals 14A and 14B, respectively, on a mounting surface 10A of the base body 10.

The external terminals 14A and 14B are disposed on the lower surface (the −Z surface), which is the mounting surface 10A of the base body 10, and on portions of side surfaces near the −Z side. The lead-out portions 12B and 12C are connected to the external terminals 14A and 14B, respectively, on the mounting surface 10A of the base body 10. The lead-out portions 12B and 12C may be connected to the external terminals 14A and 14B on the +X side surface and the −X side surface of the base body 10, respectively. Thus, the external terminals 14A and 14B are electrically connected to the coil conductor 12 and disposed on the surface of the base body 10.

The coil component 100 is mounted on a mounting substrate 16. Lands 18A and 18B are disposed on the upper surface (+Z surface) of the mounting substrate 16. The external terminals 14A and 14B are bonded to the lands 18A and 18B by a bonding material such as solder.

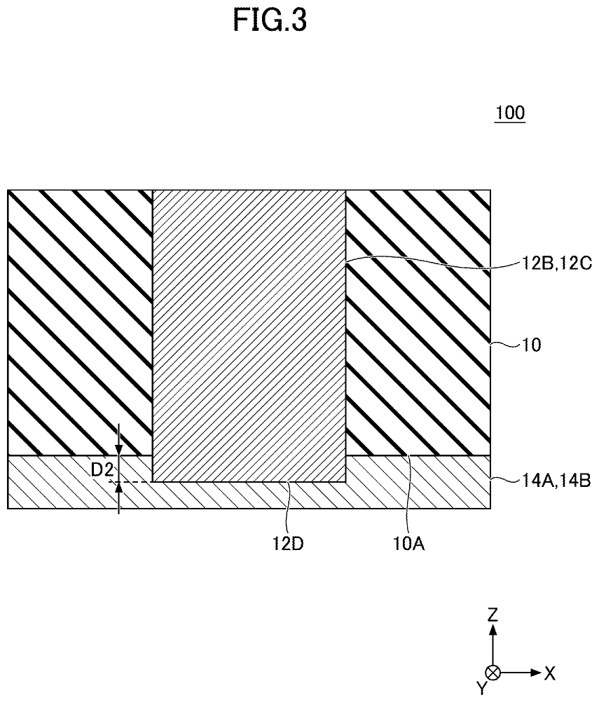

FIG. 3 is a cross-sectional view of the coil component according to the first embodiment. As illustrated in FIG. 3, the lead-out portions 12B and 12C protrude from the mounting surface 10A of the base body 10. The external terminals 14A and 14B contact side surfaces and lower surfaces of the protruding lead-out portions 12B and 12C. This can improve adhesion between the external terminals 14A and 14B and the lead-out portions 12B and 12C.

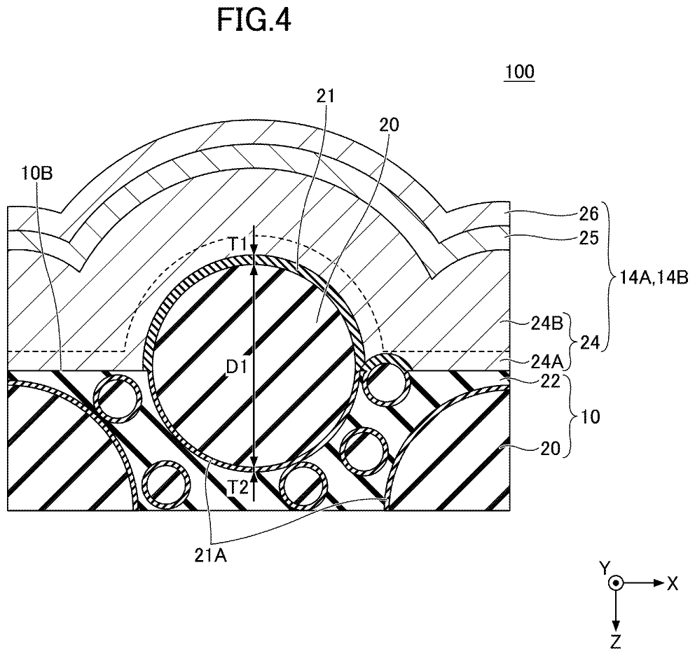

FIG. 4 is a cross-sectional view of the interface between the base body and the external terminals in the first embodiment. The figure is inverted upside down relative to FIGS. 2 and 3. As illustrated in FIG. 4, the base body 10 contains metal magnetic particles 20 and a resin 22. The resin 22 serves as a binder for the metal magnetic particles 20. A metal oxide film 21A covers the surfaces of the metal magnetic particles 20 within the resin 22. Some of the metal magnetic particles 20 protrude in the −Z direction from the resin 22. A metal oxide film 21 covers portions of the surfaces of the metal magnetic particles 20 that protrude from the resin 22. The thickness T1 of the metal oxide film 21 is larger than the thickness T2 of the metal oxide film 21A. The external terminals 14A and 14B have a first metal layer 24, a second metal layer 25, and a third metal layer 26. The first metal layer 24 may have a first plating layer 24A in contact with the resin 22 and the metal oxide film 21, and a second plating layer 24B disposed on the first plating layer 24A. The second metal layer 25 is disposed on the first metal layer 24. The third metal layer 26 is disposed on the second metal layer 25.

In the first embodiment, the length dimension of the coil component 100 in the X direction is, for example, 0.2 mm or more and 4.0 mm or less. The width dimension of the coil component 100 in the Y direction is, for example, 0.1 mm or more and 4.0 mm or less. The height dimension of the coil component 100 in the Z direction is, for example, 0.1 mm or more and 4.0 mm or less. The dimensions of the coil component 100 are not limited to the above and can be set arbitrarily.

The coil conductor 12 can be formed of a material excellent in conductivity, such as copper (Cu), silver (Ag), or nickel (Ni), and can be formed in a strip shape, for example. The surface of the coil conductor 12 may be covered with an insulating coating. The insulating coating covering the coil conductor 12 can be composed of a thermosetting resin excellent in insulation properties, for example. The insulating coating can include one or more resins excellent in insulation properties selected from polyurethane, polyamideimide, polyimide, polyester, polyester-imide, and the like.

The metal magnetic particles 20 are soft magnetic bodies and may be composed of one type of metal magnetic particles or a mixture of multiple types of metal magnetic particles. The metal magnetic particles 20 include at least one magnetic metal such as iron (Fe), nickel (Ni), and cobalt (Co), for example. The metal magnetic particles 20 may contain 70 mass % or more, or 90 mass % or more of iron, for example. The metal magnetic particles 20 may be, for example, Fe—Ni alloy, Fe—Co alloy, Fe—Si alloy, Fe—Si—Al alloy, Fe—Si—Cr alloy, Fe—Si—Al—Cr alloy, or Fe—Si—Cr—B alloy. In addition to the above, the metal magnetic particles 20 may contain at least one element selected from manganese (Mn), zinc (Zn), phosphorus (P), copper (Cu), neodymium (Nd), titanium (Ti), vanadium (V), tantalum (Ta), and tungsten (W). The average particle diameter of the metal magnetic particles 20 is, for example, 1 μm or more and 100 μm or less, and, for example, 2 μm or more and 10 μm or less.

The metal oxide films 21 and 21A mainly include an oxide of the main metal element in the metal magnetic particles 20, for example. The thickness T1 of the metal oxide film 21 is, for example, 5 nm or more and 500 nm or less, and, for example, 10 nm or more and 50 nm or less. The thickness T2 of the metal oxide film 21A is, for example, 2 nm or more and 5 nm or less.

The resin 22 is one or more types selected from epoxy resin, polyimide resin, polystyrene (PS) resin, high-density polyethylene (HDPE) resin, polyoxymethylene (POM) resin, polycarbonate (PC) resin, polyvinylidene fluoride (PVDF) resin, phenolic (Phenolic) resin, polytetrafluoroethylene (PTFE) resin, polybenzoxazole (PBO) resin, and the like, for example.

The content of the metal magnetic particles 20 in the base body 10 is, for example, 70 vol % or more, and preferably 90 vol % or more. The content of the resin 22 in the base body 10 is, for example, 3 vol % or less. The base body 10 may contain inorganic particles such as silica particles or alumina particles. The base body 10 may contain voids.

Among the external terminals 14A and 14B, the first metal layer 24 is a copper layer mainly including copper, for example. The second metal layer 25 is a nickel layer mainly including nickel, for example. The third metal layer 26 is a tin layer mainly including tin, for example. The third metal layer 26 may mainly include palladium, gold, or an alloy thereof. The first metal layer 24 is a layer in electrical contact with the coil conductor 12. The third metal layer 26 is a layer that improves wettability with solder during mounting. The second metal layer 25 is disposed between the third metal layer 26 and the first metal layer 24, and serves as an intermediate layer that suppresses a reaction between the first metal layer 24 and the third metal layer 26 by utilizing an ionization tendency lower than that of tin of the third metal layer 26, thereby facilitating formation of the third metal layer 26 on the first metal layer 24. The second metal layer 25 also serves as a barrier layer. The thickness of the first metal layer 24 is, for example, 5 μm or more and 40 μm or less, the thickness of the second metal layer 25 is, for example, 1 μm or more and 5 μm or less, and the thickness of the third metal layer 26 is, for example, 2 μm or more and 10 μm or less. The thickness of the external terminals 14A and 14B is, for example, 5 μm or more and 60 μm or less.

### Manufacturing Method of First Embodiment

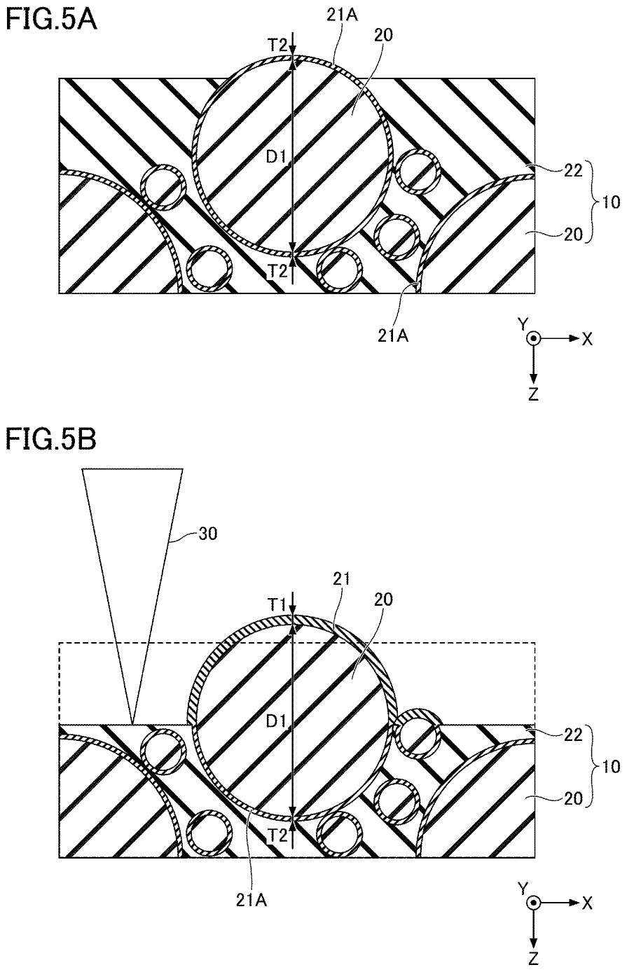

FIG. 5A and FIG. 5B are cross-sectional views illustrating the method for manufacturing the coil component according to the first embodiment. As illustrated in FIG. 5A, the base body 10 is prepared. The coil conductor 12 is embedded in the base body 10. A metal oxide film 21A formed by oxidation of the metal magnetic particles 20 is formed on the surfaces of the metal magnetic particles 20. The thickness T2 of the metal oxide film 21A is, for example, 2 nm or more and 5 nm or less. Some of the metal magnetic particles 20 are exposed from the resin 22.

As illustrated in FIG. 5B, the surface of the base body 10 is irradiated with the laser light 30. This causes the surface of the resin 22 to be abraded, thereby increasing the exposure of the metal magnetic particles 20. Furthermore, the surfaces of the metal magnetic particles 20 are oxidized, thickening the metal oxide film 21 such that the thickness T1 of the metal oxide film 21 is 10 nm or more and 50 nm or less. The reason why the metal oxide film 21 becomes thick is considered to be that the surfaces of the metal magnetic particles 20 are melted by the laser light 30, and when the molten metal solidifies again, growth of an oxide film proceeds in the surface layer of the metal, thereby thickening the metal oxide film 21. The laser light 30 to be applied includes, for example, ultraviolet, violet, or blue excimer laser light having wavelengths of 193 nm, 248 nm, and 355 nm to 450 nm, YVO₄ laser light, third harmonic light of a YAG laser, or GaN laser light. Laser light having these wavelengths is absorbed at a rate of 50% or more by the metal magnetic particles 20 and the resin 22. This allows the metal magnetic particles 20 and the resin 22 to be heated. In particular, when the laser light 30 is applied to the resin 22, the resin 22 is decomposed by a photochemical reaction and/or removed by ablation. Due to this removal, residue or scum is unlikely to remain, thereby making it less likely to hinder the plating process illustrated in FIG. 4.

Thereafter, as illustrated in FIG. 4, the external terminals 14A and 14B are formed on the surface of the base body 10. The external terminals 14A and 14B are formed by a plating method, for example. The first metal layer 24 may be formed by multiple plating processes. For example, a plating solution with a low copper ion concentration in the plating solution is used in the first plating process. A plating solution with a high copper ion concentration in the plating solution is used in the second plating process. In the first plating process, metal ions in the metal oxide film 21 are substituted with copper in the plating solution, forming a thin first plating layer 24A on the metal oxide film 21. In the second plating process, a thick second plating layer 24B is formed on the thin first plating layer 24A. In the first plating process, substitution of metal ions in the metal oxide film 21 with copper in the plating solution improves adhesion of the external terminals 14A and 14B. In the second plating process, the high copper ion concentration in the plating solution allows formation of the thick second plating layer 24B. Additional plating layers may be formed on the second plating layer 24B.

### Comparative Embodiment

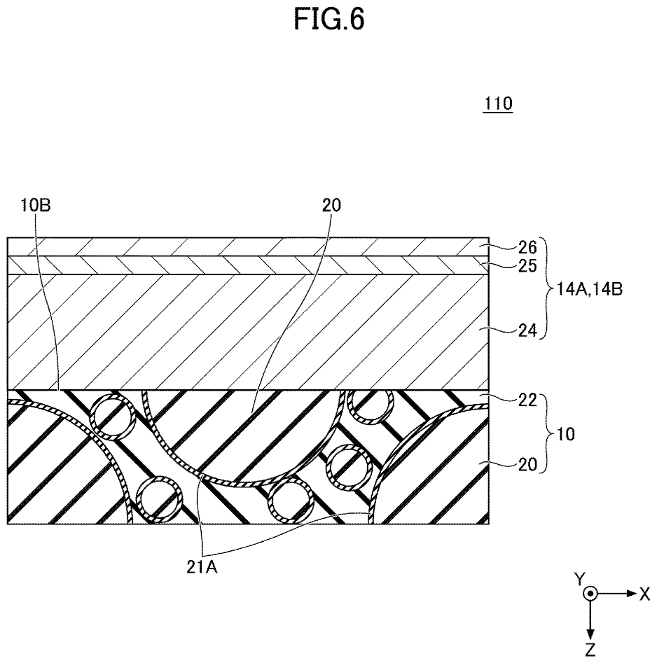

FIG. 6 is a cross-sectional view of the interface between the base body and the external terminals in the comparative embodiment. As illustrated in FIG. 6, in a coil component 110 of the comparative embodiment, a thick metal oxide film is not formed on the surfaces of the metal magnetic particles 20, and a thin metal oxide film 21A is formed. The metal oxide film 21A is a natural oxide film of the metal magnetic particles 20.

When the first metal layer 24 is formed by a plating method, metal in the metal magnetic particles 20 is substituted with metal ions in the plating solution. This causes some metal elements (e.g., iron) in the metal magnetic particles 20 to dissolve in the plating solution and be replaced with the metal (e.g., copper) in the plating solution. This reduces the size of the metal magnetic particles 20 near the surface of the base body 10. As a result, the magnetic material in the base body 10 decreases, degrading characteristics such as inductance of the coil component 110. Additionally, irregularities at an interface 10B between the base body 10 and the external terminals 14A and 14B decrease, reducing adhesion between the external terminals 14A and 14B and the base body 10. This may cause reduced bonding strength between the external terminals 14A and 14B and the base body 10 or reduced durability of the coil component, leading to reduced reliability.

### Description of First Embodiment

According to the first embodiment, as illustrated in FIG. 4, the metal oxide film 21 (first metal oxide film) is disposed on the surfaces of the metal magnetic particles 20 at the interface between the external terminals 14A and 14B and the base body 10. The external terminals 14A and 14B are in contact with the metal oxide film 21. This suppresses dissolution of metal elements of the metal magnetic particles 20 in the plating solution when forming the external terminals 14A and 14B. Thus, degradation of characteristics such as inductance in the coil component 100 can be suppressed. Additionally, adhesion between the external terminals 14A and 14B and the base body 10 can be improved, suppressing reduction in bonding strength between the external terminals 14A and 14B and the base body 10. Furthermore, reduction in durability of the coil component and other reliability issues can be suppressed.

The ionization tendency of a main metal element of the metal magnetic particles 20 is higher than the ionization tendency of a main metal element of the first metal layer 24 of the external terminals 14A and 14B that is in contact with the metal oxide film 21. In this case, during a plating process, the main metal element of the metal magnetic particles 20 is more likely to be substituted with the main metal element of the first metal layer 24. Therefore, it is preferable to provide the metal oxide film 21.

As such metal elements, the first metal layer 24, which is one of the external terminals 14A and 14B and is in contact with the metal oxide film 21, is a copper layer mainly including copper, and the metal magnetic particles 20 mainly include iron. In this case, the main metal element of the metal magnetic particles 20 is likely to be substituted with the main metal element of the first metal layer 24. Therefore, providing the metal oxide film 21 is preferable.

The metal oxide film 21 mainly includes iron oxide. This allows formation of the metal oxide film 21 by oxidizing the metal magnetic particles 20 as illustrated in FIG. 5B.

The main component iron oxide in the metal oxide film 21 includes trivalent iron. This makes the metal oxide film 21 conductive or semiconductive, thereby allowing the first metal layer 24 to be formed on the metal oxide film 21 during the plating process. Iron oxide including trivalent iron is Fe₃O₄ (magnetite) or Fe₂O₃ (hematite). The metal oxide film 21 may include microcrystals of at least one of magnetite and hematite. The metal oxide film 21 may be mostly amorphous and include trivalent iron.

As illustrated in FIG. 4, a metal oxide film 21A (second metal oxide film) is disposed on surfaces of the metal magnetic particles 20, the metal oxide film 21A being in contact with the resin 22, and having a thickness smaller than a thickness of the metal oxide film 21. As illustrated in FIG. 5B, when the metal oxide film 21 is formed, the thickness T1 of the metal oxide film 21 becomes larger than the thickness T2 of the metal oxide film 21 corresponding to a natural oxide film. The thickness T1 is preferably 2 times or more, more preferably 5 times or more the thickness T2. From the viewpoint of suppressing dissolution of the main metal element of the metal magnetic particles 20 when forming the first metal layer 24, the thickness T1 is preferably 5 nm or more, more preferably 10 nm or more. If the thickness T1 is too large, plating of the first metal layer 24 becomes difficult. From this viewpoint, the thickness T1 is preferably 500 nm or less, more preferably 50 nm or less. Since the metal oxide film 21A is a natural oxide film, the thickness T2 is preferably 100 nm or less. The thickness T2 may be substantially 0 nm.

The first metal layer 24 has a first plating layer 24A in contact with the metal oxide film 21 and a second plating layer 24B. When using a plating solution with low copper ion concentration for the first plating process and a plating solution with high copper ion concentration for the second plating process, the second plating layer 24B has copper particles with an average particle diameter larger than the average particle diameter of copper particles in the first plating layer 24A. This can improve adhesion between the external terminals 14A and 14B and the base body 10.

The average particle diameter of copper particles in the second plating layer 24B is preferably 2 times or more, more preferably 10 times or more the average particle diameter of copper particles in the first plating layer 24A. The average particle diameter of copper particles in the first plating layer 24A is, for example, 10 nm or more and 100 nm or less. The average particle diameter of copper particles in the second plating layer 24B is, for example, 0.1 μm or more and 5 μm or less. The thickness of the first plating layer 24A is, for example, 10 nm or more and 1.5 μm or less. The thickness of the second plating layer 24B is more than one times the thickness of the first plating layer 24A, for example, 10 times or more.

The average particle diameter of the metal magnetic particles 20, copper particles, and the like is determined, for example, by obtaining a volume-based particle size distribution based on SEM (Scanning Electron Microscope) images or TEM (Transmission Electron Microscope) images of a cross-section of the base body 10. The average particle diameter is determined based on the obtained volume-based particle size distribution. For example, the average particle diameter (median diameter (D50)) calculated from the volume-based particle size distribution of the metal magnetic particles obtained based on SEM images or TEM images can be used as the average particle diameter.

The thicknesses of the metal oxide films 21 and 21A, the first plating layer 24A, the second plating layer 24B, and the like are obtained from TEM (Transmission Electron Microscope) images, for example. When the thickness is uneven, an average thickness obtained from the images is used.

As illustrated in FIG. 4, at the interface between the external terminals 14A and 14B and the base body 10, the metal magnetic particles 20 protrude from the resin 22 toward the external terminals 14A and 14B. For example, 50% or more of the surface of the metal magnetic particles 20 is exposed from the resin 22. This increases the area in which the first metal layer 24 is in contact with the metal oxide film 21, thereby improving adhesion of the external terminals 14A and 14B to the base body 10.

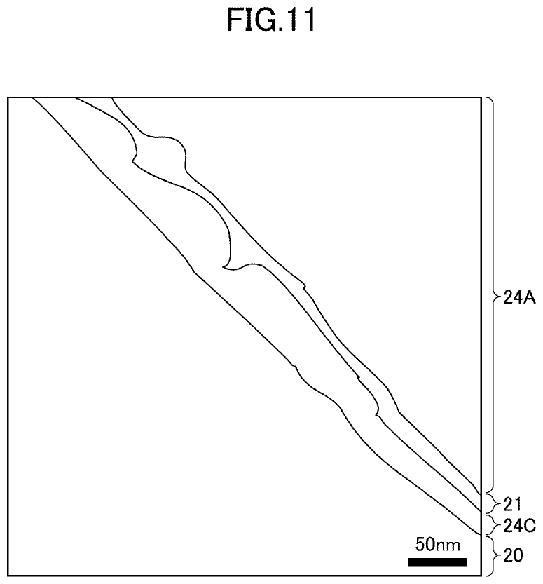

As will be described later with reference to FIG. 11 of an embodiment, a first region and a second region are disposed between the external terminals 14A and 14B and the metal magnetic particles 20, the first region being a region in which the metal oxide film 21 is in contact with the metal magnetic particles 20, and the second region being in a region in which a layer mainly including copper is disposed between the metal oxide film 21 and the metal magnetic particles 20. Pinholes or scratches may be formed in the metal oxide film 21. In such cases, the plating solution may be introduced between the metal oxide film 21 and the metal magnetic particles 20, thereby forming a layer mainly including copper. Even in such cases, when a layer mainly including copper is formed between the metal magnetic particles 20 and the metal oxide film 21, further substitution of the metal of the metal magnetic particles 20 with copper is suppressed.

As illustrated in FIG. 1, when the winding portion 12A of the coil conductor 12 is flat, the coil conductor 12 is embedded in the base body 10, and the external terminals 14A and 14B are formed by a plating process. This makes substitution of the metal magnetic particles 20 likely. Therefore, providing the metal oxide film 21 between the metal magnetic particles 20 and the external terminals 14A and 14B is preferable. For example, the width of the coil conductor 12 in the Z direction in the winding portion 12A is 2 times or more the thickness of the coil conductor 12 in the winding portion 12A. The lead-out portions 12B and 12C may also be flat.

As illustrated in FIG. 3, ends of the lead-out portions 12B and 12C of the coil conductor 12 protrude from the base body 10. This makes the contact area between the lead-out portions 12B and 12C and the external terminals 14A and 14B larger than the area of an end face 12D of the lead-out portions 12B and 12C. Thus, adhesion between the coil conductor 12 and the external terminals 14A and 14B improves. Additionally, contact resistance between the coil conductor 12 and the external terminals 14A and 14B can be reduced. The contact area between the lead-out portion 12B (and 12C) and the external terminal 14A (and 14B) is preferably 1.1 times or more, more preferably 1.2 times or more the area of the end face 12D in the lead-out portion 12B (and 12C). The protrusion amount D2 of the end face 12D from the base body 10 is preferably 5 μm or more. From the viewpoint of covering the protruding portions with the external terminals 14A and 14B, the protrusion amount D2 is preferably 50 μm or less.

From the viewpoint of improving adhesion of the external terminals 14A and 14B, the area of the end face 12D of the lead-out portion 12B (and 12C) is preferably 2% or more, more preferably 10% or more of the area where the external terminals 14A (and 14B) contact the base body 10 and the lead-out portion 12B (and 12C).

The metal oxide film 21 in the coil component 100 of the first embodiment can be realized by irradiating the surface of the base body 10 with the laser light 30 to oxidize the surfaces of the metal magnetic particles 20, as illustrated in FIG. 5B.

When forming a copper layer mainly including copper as the external terminals 14A and 14B by a plating method, the main metal element of the metal magnetic particles 20 has a high ionization tendency than copper, and the main metal element of the metal magnetic particles 20 would be substituted with copper. Therefore, providing the metal oxide film 21 between the metal magnetic particles 20 and the external terminals 14A and 14B is preferable.

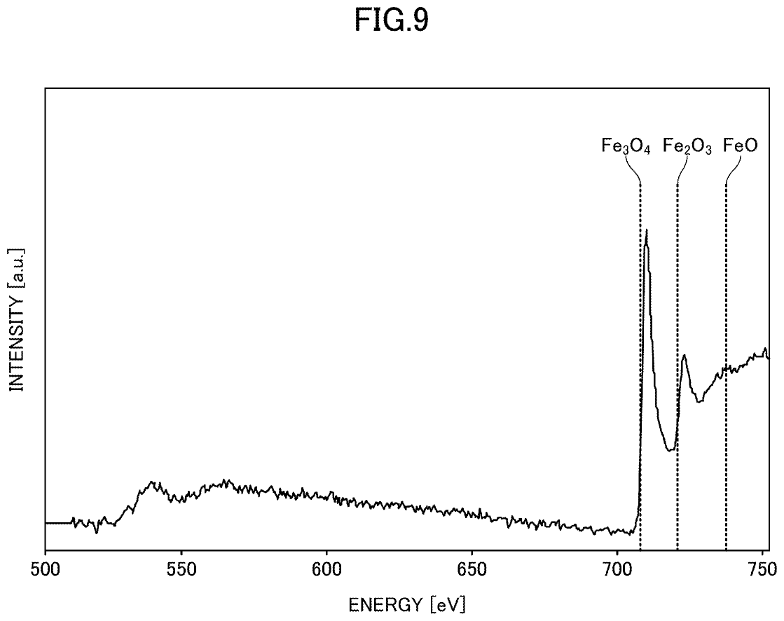

As illustrated in FIG. 5A, in the step of preparing the base body 10, as described later with reference to FIG. 9 of the example, the metal magnetic particles 20 include metal magnetic particles having shapes where multiple particles are bonded, in addition to spherical, oblate, prolate, and elongated oval shapes. The shapes where multiple particles are bonded are, for example, dumbbell-shaped or multi-branched.

### EXAMPLE

A coil component of the example was fabricated. For the metal magnetic particles 20, an alloy containing 90 mass % or more of iron was used. For forming the first metal layer 24, a plating solution with low copper ion concentration was used in the first plating process, and a plating solution with high copper ion concentration was used in the second plating process.

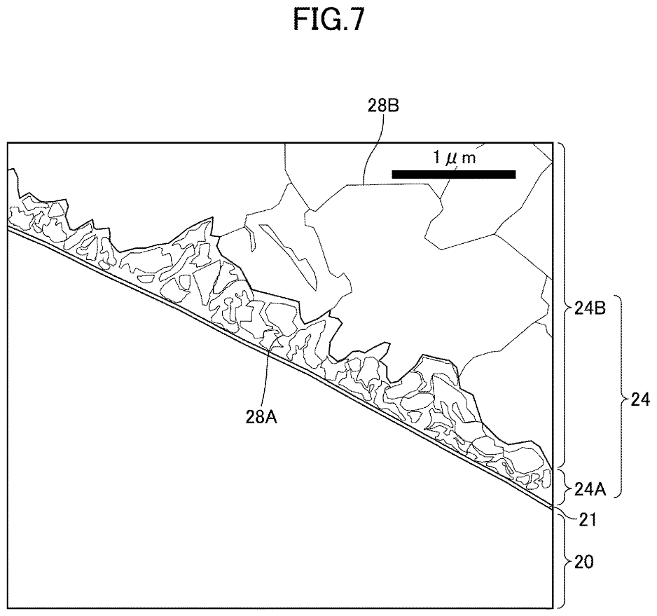

FIG. 7 is a TEM image of the interface between the metal magnetic particle and the first metal layer in the example. As illustrated in FIG. 7, a thin metal oxide film 21 is observed between the metal magnetic particle 20 and the first metal layer 24. The first metal layer 24 has a first plating layer 24A formed in the first plating process and a second plating layer 24B formed in the second plating process. Structures observed in the first plating layer 24A are copper particles 28A, and structures observed in the second plating layer 24B are copper particles 28B. The particle diameter of the copper particles 28A in the first plating layer 24A is smaller than the particle diameter of the copper particles 28B in the second plating layer 24B. The first plating layer 24A is thinner than the second plating layer 24B.

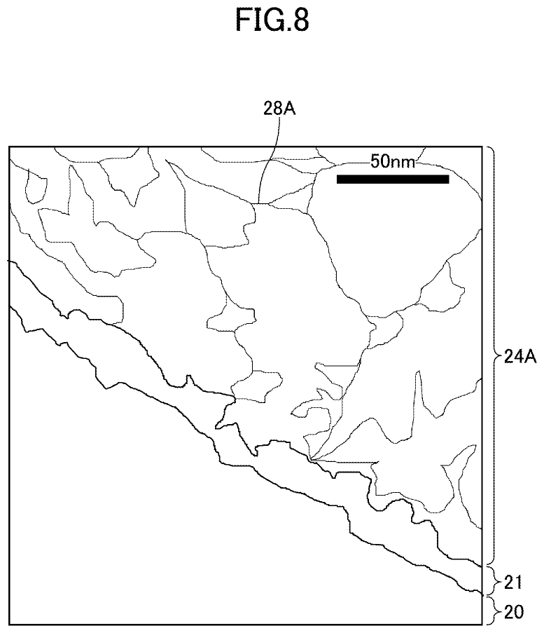

FIG. 8 is a TEM image of the interface between the metal magnetic particle and the first plating layer in the example. FIG. 8 has a higher magnification than FIG. 7. As illustrated in FIG. 8, a thin metal oxide film 21 is observed between the metal magnetic particle 20 and the first plating layer 24A. Structures in the first plating layer 24A are copper particles 28A. The thickness of the metal oxide film 21 is uneven, ranging from 10 nm to 50 nm. The average thickness is about 30 nm.

The metal oxide film 21 was analyzed using STEM-EELS (Scanning TEM Electron Energy-Loss Spectroscopy). FIG. 9 is an EELS spectrum of the metal oxide film in the example. In FIG. 9, Fe₃O₄, Fe₂O₃, and FeO indicate peak positions due to Fe₃O₄, Fe₂O₃, and FeO, respectively. Peaks of Fe₃O₄, Fe₂O₃, and FeO are observed, with particularly high peaks for Fe₃O₄ and Fe₂O₃. Fe₃O₄ includes trivalent and divalent iron, and Fe₂O₃ includes trivalent iron. Thus, the metal oxide film 21 includes trivalent iron.

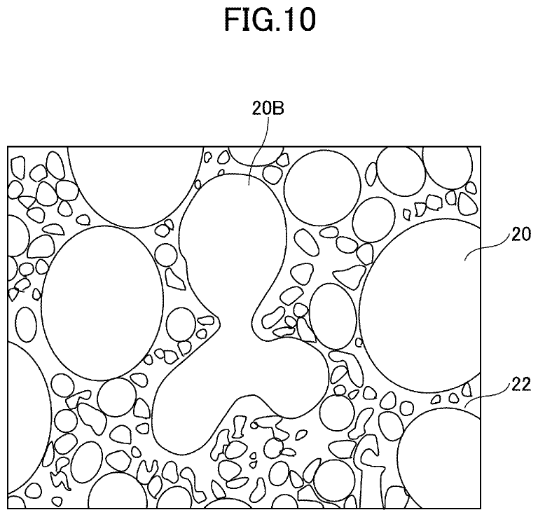

FIG. 10 is an SEM image of the base body before laser light irradiation in the example. As illustrated in FIG. 10, even in the state of FIG. 5A before laser light irradiation, the metal magnetic particles 20 include metal magnetic particles 20B having shapes where multiple particles are bonded, in addition to spherical, oblate, prolate, and elongated oval shapes.

FIG. 11 is a TEM image of the interface between the metal magnetic particle and the first plating layer in the example. FIG. 11 is an image of a different region from FIG. 7. As illustrated in FIG. 11, a third plating layer 24C is observed between the metal oxide film 21 and the metal magnetic particle 20. The third plating layer 24C is a layer mainly including copper and is considered to be formed by introducing the plating solution between the metal oxide film 21 and the metal magnetic particle 20 when pinholes or scratches are formed in the metal oxide film 21.

A certain element being a main component of a layer or particles means that a concentration of the element in the layer or the particles is, for example, 50 mass % or more, 80 mass % or more, or 90 mass % or more.

The embodiments have been described in detail above, but the present disclosure is not limited to specific embodiments, and various modifications and changes are possible within the scope described in the claims.

The aspects of the present disclosure include, for example, the following.
<1> A coil component including:
   a base body containing metal magnetic particles and a resin;
   a coil conductor disposed in the base body;
   external terminals electrically connected to the coil conductor and disposed on a surface of the base body; and
   a first metal oxide film disposed on surfaces of the metal magnetic particles at an interface between the external terminals and the base body, the first metal oxide film being in contact with the external terminals.
<2> The coil component according to <1>, wherein an ionization tendency of a main metal element of a layer, of the external terminals, that is in contact with the first metal oxide film is lower than an ionization tendency of a metal element of the metal magnetic particles is lower than an ionization tendency of a main metal element of the metal magnetic particles.
<3> The coil component according to <1>, wherein the external terminals have a copper layer that mainly includes copper and that is in contact with the first metal oxide film, and the metal magnetic particles mainly include iron.
<4> The coil component according to <3>, wherein the first metal oxide film mainly includes iron oxide.
<5> The coil component according to <4>, wherein the iron oxide includes trivalent iron.
<6> The coil component according to any one of <1> to <5>, further including:
   a second metal oxide film disposed on surfaces of the metal magnetic particles, the second metal oxide film being in contact with the resin and having a thickness smaller than a thickness of the first metal oxide film.
<7> The coil component according to any one of <3> to <5>, wherein the copper layer has a first plating layer that is in contact with the first metal oxide film and a second plating layer that is in contact with the first plating layer and that has copper particles having an average particle diameter larger than an average particle diameter of copper particles of the first plating layer.
<8> The coil component according to any one of <1> to <7>, wherein, at the interface between the external terminals and the base body, the metal magnetic particles protrude from the resin toward the external terminals.
<9> The coil component according to any one of <1> to <8>, wherein a first region and a second region are disposed between the external terminals and the metal magnetic particles, the first region being a region in which the first metal oxide film is in contact with the metal magnetic particles, and the second region being a region in which a third layer mainly including copper is disposed between the first metal oxide film and the metal magnetic particles.
<10> The coil component according to any one of <1> to <9>, wherein ends of the coil conductor protrude from the base body.
<11> A method for manufacturing a coil component, the method including:
   preparing a base body containing metal magnetic particles and a resin, with a coil conductor embedded in the base body;
   forming a metal oxide film on surfaces of the metal magnetic particles on a surface of the base body; and
   forming external terminals on the surface of the base body, the external terminals being electrically connected to the coil conductor, and the metal oxide film being disposed between the external terminals and the metal magnetic particles.
<12> The method according to <11>, wherein the step of forming the metal oxide film includes irradiating the surface of the base body with laser light to oxidize the surfaces of the metal magnetic particles.
<13> The method according to <11> or <12>, wherein the step of forming the external terminals includes forming, by a plating method, a copper layer mainly including copper that is in contact with the metal oxide film.
<14> The method according to <11> or <12>, wherein, in the step of preparing the base body, the metal magnetic particles include metal magnetic particles each having a shape in which a plurality of particles are bonded together.

What is claimed is:

1. A coil component comprising:
a base body containing metal magnetic particles and a resin;
a coil conductor disposed in the base body;
external terminals electrically connected to the coil conductor and disposed on a surface of the base body; and
a first metal oxide film disposed on surfaces of the metal magnetic particles at an interface between the external terminals and the base body, the first metal oxide film being in contact with the external terminals.

2. The coil component according to claim 1, wherein an ionization tendency of a main metal element of a layer, of the external terminals, that is in contact with the first metal oxide film is lower than an ionization tendency of a metal element of the metal magnetic particles is lower than an ionization tendency of a main metal element of the metal magnetic particles.

3. The coil component according to claim 1, wherein the external terminals have a copper layer that mainly includes copper and that is in contact with the first metal oxide film, and the metal magnetic particles mainly include iron.

4. The coil component according to claim 3, wherein the first metal oxide film mainly includes iron oxide.

5. The coil component according to claim 4, wherein the iron oxide includes trivalent iron.

6. The coil component according to claim 1, further comprising:
a second metal oxide film disposed on surfaces of the metal magnetic particles, the second metal oxide film being in contact with the resin and having a thickness smaller than a thickness of the first metal oxide film.

7. The coil component according to claim 3, wherein the copper layer has a first plating layer that is in contact with the first metal oxide film and a second plating layer that is in contact with the first plating layer and that has copper particles having an average particle diameter larger than an average particle diameter of copper particles of the first plating layer.

8. The coil component according to claim 1, wherein, at the interface between the external terminals and the base body, the metal magnetic particles protrude from the resin toward the external terminals.

9. The coil component according to claim 1, wherein a first region and a second region are disposed between the external terminals and the metal magnetic particles, the first region being a region in which the first metal oxide film is in contact with the metal magnetic particles, and the second region being a region in which a third layer mainly including copper is disposed between the first metal oxide film and the metal magnetic particles.

10. The coil component according to claim 1, wherein ends of the coil conductor protrude from the base body.
